(19) United States
(12) Patent Application Publication
(10) Pub. No.: US 2021/0144697 A1
(43) Pub. Date: May 13, 2021

(54) RESOURCE RESERVATION SYSTEM AND RESOURCE USAGE METHOD

(71) Applicant: Ken NOROTA, Kanagawa (JP)

(72) Inventor: Ken NOROTA, Kanagawa (JP)

(73) Assignee: Ricoh Company, Ltd., Tokyo (JP)

(21) Appl. No.: 17/088,999

(22) Filed: Nov. 4, 2020

(30) Foreign Application Priority Data
Nov. 7, 2019 (JP) 2019-202473

(51) Int. Cl. H04W 72/04

(52) U.S. Cl. CPC H04W 72/048

(57) ABSTRACT

A resource reservation system includes an information processing apparatus configured to accept a request to use a resource that is reserved; and an information processing terminal configured to communicate with a terminal apparatus. The information processing terminal includes a communicator configured to transmit, to the information processing apparatus, identification information of the terminal apparatus received from the terminal apparatus. The information processing apparatus includes a resource manager configured to determine whether to allow usage of the resource that is reserved, based on the identification information of the terminal apparatus transmitted from the information processing terminal.

### CROSS-REFERENCE TO RELATED APPLICATION

The present application is based on and claims priority under 35 U.S.C. § 119 to Japanese Patent Application No. 2019-202473, filed on Nov. 7, 2019, the contents of which are incorporated herein by reference in their entirety.

### BACKGROUND OF THE INVENTION

### 1. Field of the Invention

The present invention relates to a resource reservation system and a resource usage method.

### 2. Description of the Related Art

A resource reservation system for reserving a facility such as a conference room, etc., is known. A typical resource reservation system allows a user to reserve a conference room by operating a terminal apparatus connected to a reservation management server via a network.

A technique for improving the usability when making a reservation with respect to the reservation management server, has been devised (see, for example, Patent Document 1). Patent Document 1 discloses a conference room reservation system in which a user is identified by an integrated circuit (IC) card held by the user, and a conference room provided with a room-front terminal is reserved.
Patent Document 1: Japanese Patent No. 6309362

### SUMMARY OF THE INVENTION

According to one aspect of the present invention, there is provided a resource reservation system including an information processing apparatus configured to accept a request to use a resource that is reserved; and an information processing terminal configured to communicate with a terminal apparatus, wherein the information processing terminal includes a communicator configured to transmit, to the information processing apparatus, identification information of the terminal apparatus received from the terminal apparatus, and the information processing apparatus includes a resource manager configured to determine whether to allow usage of the resource that is reserved, based on the identification information of the terminal apparatus transmitted from the information processing terminal.

### BRIEF DESCRIPTION OF THE DRAWINGS

FIG. 1 is an example of a schematic diagram illustrating the overall operation of a resource reservation system of the related art;

FIG. 2 is a schematic diagram illustrating a check-in method according to an embodiment of the present invention;

FIG. 3 is an example of a system configuration diagram of the resource reservation system according to an embodiment of the present invention;

FIG. 4 is an example of a hardware configuration diagram of a conference management server according to an embodiment of the present invention;

FIG. 5 is an example of a hardware configuration diagram of a conference room terminal according to an embodiment of the present invention;

FIG. 6 is an example of a function block diagram illustrating the functions of a reservation management server, a chat server, a conference management server, and a registration terminal in a block pattern according to an embodiment of the present invention;

FIG. 7 is an example of a functional block diagram illustrating the functions of a terminal apparatus and a conference room terminal in a block pattern according to an embodiment of the present invention;

FIG. 8 is an example of a sequence diagram explaining the steps from the reservation of a conference room to the display of the standby screen according to an embodiment of the present invention;

FIG. 9 is a diagram illustrating an example of a standby screen displayed by a conference room terminal when a conference room is presently vacant according to an embodiment of the present invention;

FIG. 10 is a diagram illustrating an example of a standby screen displayed by a conference room terminal when a conference room is presently vacant but the present time is within a predetermined time period until the start time of the next conference according to an embodiment of the present invention;

FIG. 11 is a diagram illustrating an example of a standby screen displayed by the conference room terminal when the conference room is presently in use according to an embodiment of the present invention;

FIG. 12 is an example of a sequence diagram illustrating a process or an operation when a reserver or participant checks in by transmitting identification information of a terminal apparatus to a conference room terminal according to an embodiment of the present invention;

FIG. 13 is a diagram illustrating an example of an input screen of conference identification information displayed by a conference room terminal according to an embodiment of the present invention;

FIGS. 14A and 14B are examples of diagrams explaining the transition of the screen displayed by the terminal apparatus (part 1) according to an embodiment of the present invention;

FIGS. 15A and 15B are examples of diagrams explaining the transition of the screen displayed by the terminal apparatus (part 2) according to an embodiment of the present invention;

FIG. 16 is an example of a flowchart illustrating the process or operation of the conference management server that has received the identification information of the terminal apparatus according to an embodiment of the present invention;

FIG. 17 is an example of a flowchart illustrating a process or operation in which the conference management server that has received the conference identification information registers the identification information of the terminal apparatus according to an embodiment of the present invention;

FIG. 18 is a diagram illustrating an example of screen transition when a user registers identification information of a terminal apparatus in the conference management server at any timing according to an embodiment of the present invention; and

FIG. 19 is an example of a flowchart illustrating a registration process performed by the information processing apparatus that has received the identification information of the terminal apparatus, the user name, and a password according to an embodiment of the present invention.

### DETAILED DESCRIPTION OF THE PREFERRED EMBODIMENTS

In the conventional technology, there have been problems in that it is inconvenient when the user starts using a reserved resource (e.g., a conference room). For example, when a user performs an operation to start using an information processing terminal installed in a conference room and the like, it is necessary for the user to manually input identification information (conference identification information, etc.) for authentication, that has been previously distributed. Alternatively, identification information needs to be input to an application of a terminal apparatus such as a smartphone held by the user, and the terminal apparatus needs to be passed over the information processing terminal. Alternatively, a user needs to pass, over the information processing terminal, an exclusive-use integrated circuit (IC) card prepared for inputting the start of use to the information processing terminal. In this manner, in order to start using a resource, it has been necessary for the user to perform an input operation or to hold an exclusive-use IC card, and, therefore, there have been inconvenient cases.

A problem to be addressed by an embodiment of the present invention is to provide a resource reservation system in which the convenience when a user starts using a reserved resource, is improved.

Hereinafter, as an example of an embodiment of the present invention, a resource reservation system and a resource usage method performed by the resource reservation system will be described with reference to the drawings.

### <Overview of Resource Reservation System>

First, an overview of a resource reservation system is described with reference to FIG. 1. FIG. 1 is an example of a diagram illustrating an overview of the overall operations of a resource reservation system 100.

A. The reserver operates his/her terminal apparatus 60 to communicate with a reservation management server 20 and reserves a conference room. The reservation management server 20 is a general-purpose cloud service (Office 365, G Suite (both registered trademarks), etc.), and a conference room owned by an organization such as a company to which the reserver belongs, is registered in the reservation management server 20.

B. A conference management server 30 is a server that controls the entire resource reservation system 100 based on the reservation status of a conference room. The conference management server 30 appropriately communicates with the reservation management server 20 to acquire reservation information, and, therefore, the conference management server 30 synchronizes the reservation information with that of the reservation management server 20.

C. The resource reservation system 100 or the administrator on the organization side can register a user and make various settings with respect to the conference management server 30. Registering a user means the registering of a user that is a target of various reports using a chat server 10 (slack, LINE, Microsoft Teams (all registered trademarks, hereinafter omitted), etc.). The reporting is performed via bot that transmits a message as the conference management server 30, and, therefore, the bot provided by the chat server is also registered. Various settings include registration of a conference room terminal 90 (the initial setting to be described later) and setting of the timing of a reminder.

D. The conference management server 30 reminds the reserver that the conference will be held, at a fixed time prior to the start time of the conference in the reservation information. This will reduce the occurrence of situations where the conference room is reserved but is not actually used. The conference management server 30 reports, to the user, conference identification information (equivalent to an invitation code) as necessary. The conference reserver stores, in the terminal apparatus 60, information (conference identification information) for checking in to the conference room by receiving reminders. Checking in means starting to use a conference room (resource).

E. The conference room terminal 90 is disposed in each conference room 6, and the conference room terminal 90 downloads the reservation information of a conference to be held in the corresponding conference room on a regular basis. The conference room terminal 90 may display the schedule for the day or the latest conference so that the participant of the conference can confirm the schedule. Shortly before the start time of the conference, the reserver of the conference room will be able to go to the conference room 6 and check in to the conference room 6. At the time of check-in, for example, the reserver inputs the conference identification information to the conference room terminal 90, or passes the terminal apparatus 60 over the conference room terminal 90 (for example, to cause the conference identification information to be read or communicated).

F. The conference room terminal 90 transmits a check-in request (a usage request for requesting to use the conference room) to the conference management server 30, and, therefore, when the reserver can be authenticated by the conference identification information, the conference room terminal 90 receives a response indicating that the check-in has been completed from the conference management server 30. The conference room terminal 90 displays a message indicating in use (during conference; a conference is being held). When a usage start report that reports check-in cannot be confirmed within a fixed time with respect to the start time of the conference, the conference management server 30 cancels the reservation of the conference room 6 (cancels the reservation information when usage of the conference room does not start within a predetermined time) and transmits cancelled, as the status included in the reservation information, to the conference room terminal 90. In this case, the conference room terminal 90 displays that the conference room 6 is a vacant room, and, therefore, any user can use the conference room 6.

G. The conference room terminal 90 controls an electronic device 70 upon receiving a request from the conference management server 30. For example, the conference room terminal 90 turns on the power of the electronic device 70 at the start time of the conference and turns off the power of the electronic device 70 at the end time of the conference. This will improve the convenience of conference participants in operating the electronic device 70.

H. When the electronic device 70 has, for example, a video conference function, the electronic device 70 can communicate with an electronic device (such as a video conference terminal 70x) at another location 4 to hold a conference with another location. Further, a personal computer (PC) 70y on which an application operates, can communicate with the electronic device 70. The reservation information includes the destination information (the communication ID of the destination) indicating another location in advance, and the electronic device 70 can automatically communicate with the video conference terminal 70x and the PC 70y.

I. When the reserver finishes the conference, the reserver presses the exit button of the conference room terminal 90 to check out, so the conference room terminal 90 displays the next reservation status. This allows any user to be aware of the reservation status of the conference room.

### <Improvement of Check-in Method>

As described in the above-described E, in order for the user to check into the conference room terminal 90, the conference identification information needs to be input to the conference room terminal 90, which is troublesome for the user. Therefore, in the present embodiment, check-in by using the identification information of the terminal apparatus 60 is enabled, as follows.

FIG. 2 is a diagram illustrating an outline of a check-in method according to the present embodiment.

(1) When the user passes the terminal apparatus 60 over the conference room terminal 90, the terminal apparatus 60 transmits identification information to the conference room terminal 90 using a short-range radio means.
(2) The conference room terminal 90 transmits the identification information of the terminal apparatus 60 to the conference management server 30.
(3) The conference management server 30 includes user account information (an example of information stored in a first storage) and conference management information (an example of information stored in a second storage), and the conference management server 30 firstly searches for identification information of the terminal apparatus 60 in the user account information. The conference management server 30 determines whether the identification information of the terminal apparatus 60 is found by the search and whether the fact that the user has reserved a conference room is registered in the conference management information.
(4) When it is registered that the user has reserved a conference room in the conference management information, the conference management server 30 allows the user to check in. It is more preferable that the check-in is allowed only to a conference room to which check-in is possible.

Accordingly, the user can check into the conference room terminal 90 by a simple operation of passing the terminal apparatus 60 over the conference room terminal 90. The user does not need to input conference identification information or use an exclusive-use IC card.

(5) In the user account information, when the identification information of the terminal apparatus 60 is not found by the search, the conference management server 30 displays an input screen for inputting the conference identification information on the conference room terminal 90 and prompts the user to input the conference identification information.
(6) When the user inputs the conference identification information, the conference management server 30 determines whether the input conference identification information is registered in the conference management information, allows the check-in when the conference identification information is registered, and identifies a user (reserver) based on the conference management information. The conference management server 30 registers the identification information of the identified user and the terminal apparatus in the user account information.

Accordingly, at the time of checking in to the conference the next time, when the user passes the terminal apparatus 60 over the conference room terminal 90, the user is identified from the identification information of the terminal apparatus 60, and the check-in to the conference room reserved by the user is allowed.

As described above, the check-in is enabled by simply passing the terminal apparatus 60 owned by the user over the conference room terminal 90. Further, the identification information of the terminal apparatus 60 can be registered in the conference management server 30.

### Terminology

A resource is, for example, a conference room, equipment available for use in the conference room, an apparatus, a person, and a mechanism. A resource that is difficult to move is referred to as a facility. As a matter of explanation, the term conference room is used in the present embodiment as an example of a resource.

A reserver is a person who has reserved a conference room, and a participant is a person who participates in a conference. The reserver is often included among the participants but need not be included. In the present embodiment, the work performed by a reserver may be performed by a participant. People who use a conference room are collectively simply referred to as a user.

Allowing the use of a resource is to detect that the use of a resource has been started by a legitimate reserver or participant in the conferences management server. The fact that the resource has started to be used is reflected to the conference room terminal. From the user's point of view, the use of resource is allowed (has been able to check-in).

This identification information of the terminal apparatus is identification information that identifies the terminal apparatus carried by the user. The identification information is to be unique, such as a Universally Unique Identifier (QUID).

### <Example of System Configuration>

FIG. 3 is an example of a system configuration diagram of the resource reservation system 100. The resource reservation system 100 may be mainly divided into an external network N2 (outside a company) and an internal network N1 (inside a company). The internal network N1 refers to a network inside a firewall 73, and the external network N2 refers to a network such as the Internet where an unspecified number of communications is transmitted.

The reservation management server 20, the conference management server 30, and one or more of the chat servers 10 are connected to the external network N2, and each server can communicate as needed. The external network N2 may be connected to the terminal apparatus 60 operated by a participant of the conference as needed.

The reservation management server 20 is implemented by one or more information processing apparatuses (computer system) in which a typical server operating system (OS) and the like is installed. The system relating to the reservation of equipment provided by the reservation management server 20 is referred to as a reservation management system. The reservation management server 20 has a calendar system and provides a web application for managing various schedules. Specifically, the reservation management server 20 has the following functions.
Schedule registration can be accepted and the schedule can be confirmed by the reserver at any time and from anywhere.
A report can be transmitted by an e-mail at a set date and time, such as 30 minutes before the scheduled date and time
One person can manage schedules by a plurality of calendars (for work, for home, etc.)
A calendar can be shared among people in the same group

The reservation management server 20 manages a user by an account. An account is a user's right to use a service. In many systems, the user logs into the system using an account. For this reason, the account has a function (identification information function) for uniquely identifying a user by the system. According to the present embodiment, the reservation management server 20 transmits the reservation information of a previously registered account (domain) to the conference management server 30. Alternatively, when the conference management server 30 requests the reservation information by specifying the account of the reservation management server 20, the conference management server 30 can acquire the reservation information of the conference room 6 from the reservation management server 20. As the account, information that uniquely identifies the user may suffice, for example, an e-mail, an ID, a telephone number, and the like.

According to the present embodiment, the schedule that is managed is the reservation of the conference room 6, but the reservation management server 20 may manage various schedules other than the reservation of the conference room 6. In addition to the reservation of the conference room 6, the reservation management server 20 may be used for the reservation of rental of various electronic devices, the reservation of a parking lot, the reservation of rental offices, rental studios, rental bicycles, rental vehicles, and the reservation of various kinds of facilities including lodging facilities such as hotels, and rental spaces such as event venues and lockers.

As the reservation management system, G Suite (registered trademark), Office 365 (registered trademark), and the like are known, but a reservation management system having the functions described in the present embodiment is sufficient.

Further, in the present embodiment, information concerning the conference room 6 in the internal network N1 is pre-registered in the reservation management server 20. That is, the web application of the reservation management server 20 is customized according to the conference room name of each of the conference rooms 6, the conference room ID, the possible reservation time, the capacity of each of the conference rooms 6, the reservation unit and the like, in an in-house network of a company using the resource reservation system 100. Accordingly, the reservation information is associated with the conference room 6 of a company using the resource reservation system 100.

The chat server 10 may be implemented by one or more information processing apparatuses (computer system) in which a typical server OS and the like is installed. A chat system is a real-time sharing system for sharing information such as text, voice sound, videos and the like among a plurality of users provided by the chat server 10. The chat server 10 reports, to the terminal apparatus 60, information concerning the reservation of the conference room 6. In the present embodiment, a plurality of the chat servers 10 of different operating entities may be included.

The information to be shared includes images, voice sound, etc., and is not limited to text. However, as a matter of convenience of explanation, the present embodiment explains that text is mainly used for the reporting. For example, the chat system may provide a voice call function between groups. A voice call may be one-to-one or one-to-N (≥2). Accordingly, in the present embodiment, when the chat system reports the information concerning the reservation of the conference room 6, the chat system may output a voice sound message other than a text display. As the chat system, LINE, slack, Microsoft Teams (all registered trademarks) and the like are known. However, a chat system capable of reporting to one or more users from the bot (program that executes a predetermined process) may suffice.

The chat server 10 similarly manages a user with an account (different from the account of the reservation management server 20), but in principle, the conference management server 30 does not need to be aware of the account of the chat server 10. However, the conference management server 30 may specify and report any account of the chat server 10.

The conference management server 30 may be implemented by one or more information processing apparatuses (computer system) in which a typical server OS and the like is installed. As a process related to the external network N2, the conference management server 30 acquires the reservation information of the conference room 6 from the reservation management server 20, acquires the scheduled participant set in the reservation information, and transmits a report to a group (or an individual person such as a reserver) of the chat server 10 associated with the scheduled participant at a predetermined timing. Further, as a process related to the internal network N1, the conference management server 30 manages the check-in and the check-out with respect to the conference room 6, and controls the power of the electronic device 70 based on the reservation information of the conference room 6 acquired from the reservation management server 20.

The internal network N1 includes the conference room 6, a work location 101 for a scheduled participant, and a work location 102 for an administrator. Scheduled participants can access the external network N2 from various locations via the internal network N1. The internal network N1 is, for example, a local area network (LAN). The conference room 6, the scheduled participant's work location 101, and the administrator's work location 102 are not necessarily within the LAN of the same company.

The conference room terminal 90 and the electronic device 70 are disposed in the conference room 6. The conference room terminal 90 and the electronic device 70 may communicate over a small-scale LAN or an exclusive-use line. The electronic device may be connected to the internal network N1 and the external network N2 without involving the conference room terminal 90. The conference room terminal 90 and the electronic device 70 may communicate in either a wireless or wired manner. The internal network N1 is inside the firewall 73, and, therefore, direct communication from the external network N2 to the internal network N1 is difficult.

The conference room terminal 90 is an information processing apparatus (an example of an information processing terminal or an accepting terminal) operated by a participant of a conference such as a reserver who uses the conference room 6. The conference room terminal 90 is disposed on a desk in the conference room 6 or at the entrance of the conference room 6. A plurality of the conference room terminals 90 may be disposed in one of the conference rooms 6. The conference room terminal 90 may be implemented by one or more information processing apparatuses (computer system) in which a typical OS and the like is installed.

The conference room terminal 90 transmits the conference room ID to the conference management server 30 and displays the reservation information of the conference room 6 of the day. Further, control information such as power ON and OFF of the electronic device 70 is acquired from the conference management server 30. Thus, the conference room terminal 90 turns ON and OFF the power of the electronic device 70.

The conference room terminal 90 displays a standby screen for check-in, check-out, and the like, and communicates with the conference management server 30 for informing the conference management server 30 of the check-in or check-out. At the time of checking in, the conference room terminal 90 transmits the conference identification information input by the reserver and the conference room ID that is stored in advance, to the conference management server 30, and, therefore, the conference management server 30 can confirm that the reserver who has reserved the conference room 6 will use the reserved conference room 6 based on the conference identification information and the conference room ID (the present embodiment mainly describes a case in which the user checks in with the identification information of the terminal apparatus 60).

The electronic device 70 may be a variety of office devices that may be used in the conference room 6. Examples include electronic blackboards, multifunction peripherals, projectors, digital signages, digital cameras, and the like. The electronic blackboard has a large display with a touch panel, detects the coordinates on the panel indicated by the user, connects the coordinates, and displays a stroke. Further, an image of a connected PC can be displayed, and strokes can be synchronized by communicating with electronic blackboards at other locations. Incidentally, an electronic blackboard may be referred to as an electronic information board or an electronic whiteboard in some cases.

A multifunction peripheral has functions such as those of a copier, a scanner, a printer, and facsimile transmission/reception machine, and is used for printing materials during conferences, copying materials, digitizing materials, and transmitting materials. A projector is an apparatus for projecting images. For example, an image displayed on a display by the terminal apparatus 60 can be shared among the participants by projecting the image on a screen and the like. A digital signage is a large display and is used to display any still image or movie. A digital camera is used by each participant to capture and store a paper material or a material displayed on the electronic blackboard.

The terminal apparatus 60 capable of connecting to the internal network N1 is disposed at the work location 101 of a scheduled participant. The terminal apparatus 60 may communicate in a wired or wireless manner. The terminal apparatus 60 is an information processing apparatus used by a scheduled participant (including a reserver) when reserving a conference room, and it is also assumed that the terminal apparatus 60 is brought into the conference room. The terminal apparatus 60 is an information processing apparatus carried by a scheduled participant.

The terminal apparatus 60 may be implemented by one or more information processing apparatuses (computer system) in which a typical OS and the like is installed. The terminal apparatus 60 may be, for example, a smartphone, a tablet terminal, a PC, a Personal Digital Assistant (PDA), a wearable PC (a sunglass type, a wristwatch type, etc.), and the like. However, the terminal apparatus 60 may suffice as long as a communication function is included and browser software or application software exclusively used for the chat server 10 or the reservation management server 20 can operate thereon. For example, a car navigation system, a game machine, a television set, and the like may also be the terminal apparatus 60.

In the terminal apparatus 60, application software exclusively used for the chat server 10 (hereinafter, referred to as a “chat application”) is operated, and application software exclusively used for the resource reservation system 100 (hereinafter, referred to as a “conference application”) is also operated. However, these applications may be substituted with browser software.

At the administrator's work location 102, a registration terminal 50 that can be connected to the internal network N1 is disposed. The registration terminal 50 may communicate in a wired or wireless manner. The registration terminal 50 is an information processing apparatus of the administrator for making initial settings to the conference room terminal 90.

The registration terminal 50 may be an information processing apparatus similar to the terminal apparatus 60. However, the registration terminal 50 is mainly used for making settings to the conference management server 30 by the administrator, and, therefore, a chat application or a conference application need not be included. The registration terminal 50 communicates with the conference management server 30 mainly by browser software and displays a web page.

### <Hardware Configuration>

### <<Hardware Configuration of Conference Management Server>>

FIG. 4 is a diagram illustrating the hardware configuration of the conference management server 30. As illustrated in FIG. 4, the conference management server 30 is configured by a computer and includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a Digital Versatile Disk Rewritable (DVD-RW) drive 514, and a medium I/F 516.

Among these, the CPU 501 controls the operation of the entire conference management server 30. The ROM 502 stores a program used to drive the CPU 501, such as an Initial Program Loader (IPL). The RAM 503 is used as the work area of the CPU 501. The HD 504 stores various kinds of data such as a program. The HDD controller 505 controls the reading or writing of various kinds of data to the HD 504 according to the control of the CPU 501. The display 506 displays various kinds of information such as cursors, menus, windows, characters, or images. The external device connection I/F 508 is an interface for connecting various external devices. In this case, the external device may be, for example, a Universal Serial Bus (USB) memory or a printer. The network I/F 509 is an interface for performing data communication using a communication network. The bus line 510 is an address bus, a data bus, and the like for electrically connecting elements such as the CPU 501 illustrated in FIG. 4.

The keyboard 511 is a type of input means including a plurality of keys for input of characters, numbers, various instructions, and the like. The pointing device 512 is a type of input means for selecting and executing various instructions, selecting a processing target, moving a cursor, and the like. The DVD-RW drive 514 controls the reading or writing of various kinds of data to a DVD-RW 513 as an example of a removable recording medium. The removable recording medium is not limited to a DVD-RW, but may be a Digital Versatile Disc Recordable (DVD-R), etc. The medium I/F 516 controls the reading or writing (storage) of data to a recording medium 515, such as a flash memory.

The hardware configuration diagram of the reservation management server 20, the chat server 10, the registration terminal 50, and the terminal apparatus 60 is the same as that of FIG. 4, and even if the hardware configurations were different, there is no problem in the description according to the present embodiment.

### <<Hardware Configuration of Conference Room Terminal>>

FIG. 5 is an example of a hardware configuration diagram of the conference room terminal 90. Note that the conference room terminal 90 of FIG. 5 is assumed to be a tablet apparatus. As illustrated in FIG. 5, the conference room terminal 90 includes a CPU 401, a ROM 402, a RAM 403, an electrically erasable programmable read-only memory (EEPROM) 404, a Complementary Metal-Oxide-Semiconductor (CMOS) sensor 405, an imaging element I/F 406, an acceleration/bearing sensor 407, a medium I/F 409, and a global positioning system (GPS) receiving unit 411.

Among these, the CPU 401 controls the operation of the entire conference room terminal 90. The ROM 402 stores the CPU 401 and a program used to drive the CPU 401, such as an IPL. The RAM 403 is used as the work area of the CPU 401. The EEPROM 404 reads out or writes various kinds of data such as a smartphone program according to the control of the CPU 401. The CMOS sensor 405 is a type of built-in imaging means that captures a subject (mainly a self-image) according to the control of the CPU 401 to obtain image data. The CMOS sensor 405 may be an imaging means such as a Charge Coupled Device (CCD) sensor, instead of a CMOS sensor. The imaging element I/F 406 is a circuit that controls the driving of the CMOS sensor 405. The acceleration/bearing sensor 407 is a variety of sensors, such as an electromagnetic compass or a gyrocompass which detects geomagnetic fields, or an acceleration sensor. The medium I/F 409 controls the reading or writing (storage) of data to a recording medium 408, such as a flash memory. The GPS receiving unit 411 receives a GPS signal from a GPS satellite.

The conference room terminal 90 includes a long range communication circuit 412, a CMOS sensor 413, an imaging element I/F 414, a microphone 415, a speaker 416, a sound input output I/F 417, a display 418, an external device connection I/F 419, a short range communication circuit 420, an antenna 420a of the short range communication circuit 420, and a touch panel 421.

Among these, the long range communication circuit 412 is a circuit for communicating with other devices via a communication network. The CMOS sensor 413 is a type of built-in imaging means that captures a subject according to the control of the CPU 401 and obtains image data. The imaging device I/F 414 is a circuit that controls the driving of the CMOS sensor 413. The microphone 415 is a built-in circuit that converts sound to an electrical signal. The speaker 416 is a built-in circuit that converts electrical signals to physical vibrations to produce sound, such as music and speech. The sound input output I/F 417 is a circuit that processes the input and output of sound signals between the microphone 415 and the speaker 416 according to the control of the CPU 401. The display 418 is a type of display means such as a liquid crystal display or an organic Electro Luminescence (EL) display for displaying an image of a subject or various icons. The external device connection I/F 419 is an interface for connecting various external devices. The short range communication circuit 420 is a communication circuit such as a Near Field Communication (NFC) or Bluetooth (registered trademark). The touch panel 421 is a type of input means for operating the conference room terminal 90 by a user pressing the display 418.

The conference room terminal 90 also includes a bus line 410. The bus line 410 is an address bus, data bus, and the like for electrically connecting elements such as the CPU 401 illustrated in FIG. 5.

### <Function>

FIG. 6 is an example of a functional block diagram illustrating functions of the reservation management server 20, the chat server 10, the conference management server 30, and the registration terminal 50 in a block shape.

### <<Reservation Management Server>>

The reservation management server 20 includes a communicating unit 21 and a reservation information managing unit 22. Each of these functional units included in the reservation management server 20 is a function or means implemented by the elements illustrated in FIG. 4 operating in accordance with an instruction from the CPU 501 according to a program loaded from the HD 504 to the RAM 503.

The communicating unit 21 transmits and receives various kinds of information with the conference management server 30 and the terminal apparatus 60. The communicating unit 21 transmits screen information of a reservation setting screen to the terminal apparatus 60 and receives a reservation setting from the terminal apparatus 60. Further, the communicating unit 21 transmits the reservation information to the conference management server 30.

The reservation information managing unit 22 manages reservation information registered by the user. The reservation information managing unit 22 reads, from a reservation information database (DB) 291, the reservation information of the conference room 6 that is requested from the conference management server 30 by specifying a domain (per customer) of a user, and transmits the requested reservation information to the conference management server 30 via the communicating unit 21. Alternatively, when the reservation information is registered (or changed), even when a request is not received, the reservation information managing unit 22 may transmit the reservation information to the conference management server 30. It is assumed that a typical web application is used as the method by which a reserver reserves the conference room 6 in the reservation management server 20.

The reservation management server 20 includes a storage unit 29. The storage unit 29 is implemented by the RAM 503, the HD 504, and the like of FIG. 4. The reservation information DB 291 and a user information DB 292 are stored in the storage unit 29.

TABLE 1A
RESERVATION INFORMATION DB

| | | | | | | SCHEDULED |
|---|---|---|---|---|---|---|
| RESERVATION | RESERVER | CONFERENCE | CONFERENCE | START | END | PARTICIPANT |
| ID | ACCOUNT | NAME | ROOM ID | TIME | TIME | ACCOUNT |
| 001 | a@xfood.com | ARTICLE Z | K-001 | 2017/07/07 | 2017/07/07 | b@xfood.com |
| | | DEVELOPMENT | | 10:00 | 12:00 | c@xfood.com |
| | | CONFERENCE | | | | d@xfood.com |
| 002 | e@xfood.com | ARTICLE Y | K-001 | 2017/07/07 | 2017/07/07 | f@xfood.com |
| | | DEVELOPMENT | | 13:00 | 14:00 | g@xfood.com |
| | | CONFERENCE | | | | |
| . . . | . . . | . . . | . . . | . . . | . . . | . . . |

TABLE 1B

| USER NAME | PASSWORD |
|---|---|
| a@xfood.com | xxx |
| e@xfood.com | yyy |
| . . . | . . . |

Table 1A indicates an example of the reservation information stored in the reservation information DB 291. The reservation information is information to manage the reservation status of the conference room 6. In the reservation information, the items of a reserver account, a conference name, a conference room ID, a start time, an end time, and a scheduled participant account are registered in association with a reservation ID. The reservation ID is identification information that identifies one record of reservation information. ID is an abbreviation of identification and means an identifier or identification information. An ID is a name, a code, a character string, a numeric value, or a combination of one or more of these pieces of information, used to uniquely distinguish a particular target from a plurality of targets. The same applies to IDs other than reservation IDs. The reserver account is the account of the scheduled participant who has reserved the conference room 6. The conference name is any name of a conference given by a scheduled participant. The conference room ID is the identification information identifying the conference room 6 in the internal network. The start time is the start time of the time period during which the conference room 6 is reserved (the time when the conference starts), and end time is the end time of the time period during which the conference room 6 is reserved (the time when the conference ends). The scheduled participant account is the account of the scheduled participant who is scheduled to participate in the conference. All of the accounts in Table 1A are accounts issued by the reservation management server 20.

Table 1B indicates an example of user information stored in the user information DB 292. The user information includes the items of user accounts and passwords. These items are used to authenticate users.

### <<Chat Server>>

The chat server 10 includes a communicating unit 11 and a text processing unit 12. Each of these functional units of the chat server 10 is a function or means implemented by the elements illustrated in FIG. 4 operated in accordance with an instruction from the CPU 501 according to a program loaded from the HD 504 to the RAM 503.

The communicating unit 11 transmits and receives various kinds of information with the conference management server 30. According to the present embodiment, the communicating unit 11 receives, from the conference management server 30, information concerning the reservation of the conference room, information identifying the bot (a token to be described later), and information identifying the group that is the report destination. The information identifying the bot is reported in advance by the chat server 10 as the bot identification information when the bot of the conference management server 30 is created. Further, an account of an individual, such as a reserver, may be specified. Further, the communicating unit 11 transmits a message that the scheduled participant has read the information concerning the conference room reservation, or a response of the scheduled participant with respect to the information concerning the reservation of the displayed conference room, to the conference management server 30.

The text processing unit 12 transmits information concerning the reservation of the conference room 6 to the scheduled participants belonging to a group, as information to be voiced by the bot, based on the information identifying the bot reported from the conference management server 30 and the information identifying the group that is the report destination. Thus, there are cases where a report is transmitted a number of times corresponding to the number of scheduled participants and cases where a report is transmitted only to the reserver or a report destination user. Further, information concerning the reservation of the conference room 6 is transmitted only to a particular report destination.

The text processing unit 12 can transmit a so-called push report. An example of a relevant mechanism is as follows. A chat application 60a receives the ID (token) for a push report from a server operated by the manufacturer of the OS (operating system). In this server, the token is associated with the device (the terminal apparatus 60). The chat application 60a registers the token and the account of the chat application 60a in the chat server 10. When the chat server 10 transmits a push report, it is possible to identify the token with which the chat application 60a is associated because the account of the chat application 60a is identified.

The chat system transmits the report content, by specifying the token, to the server operated by the manufacturer of the OS. The server transmits a push report to the device (the terminal apparatus 60) associated with the token.

The chat server 10 includes a storage unit 19. The storage unit 19 is implemented by the RAM 503, the HD 504, and the like of FIG. 4. A group information DB 191 is stored in the storage unit 19.

TABLE 2
GROUP INFORMATION DB

| | | MEMBER | MEMBER | MEMBER | MEMBER | BOT |
|---|---|---|---|---|---|---|
| WORK SPACE | CHANNEL | ACCOUNT 1 | ACCOUNT 2 | ACCOUNT 3 | ACCOUNT 4 | ACCOUNT |
| http://sample.com/1 | #marketing | a@chat.com | b@chat.com | c@chat.com | d@chat.com | robo1@chat.com |
| http://sample.com/2 | #team1 | b@chat.com | d@chat.com | | | robo2@chat.com |
| http://sample.com/3 | #ip | f@chat.com | g@chat.com | h@chat.com | | robo3@chat.com |
| . . . | . . . | . . . | . . . | . . . | . . . | . . . |

Table 2 indicates an example of group information stored in the group information DB 191. Group information is information in which the accounts of members belonging to the same group are registered. In the group information, member accounts 1 to n (n=4 in Table 2) and bot accounts are registered in association with workspaces and channels.

A workspace is identification information to identify an organization such as a company or a department and the like. In the present embodiment, a plurality of members belong to a workspace (e.g., Company A). The workspace is, for example, a Uniform Resource Locater (URL), but any relevant workspace will suffice as long as the workspace is unique. Further, the workspace includes a plurality of channels according to the purpose of the chat and the like. The channel is an assembly of members among which common information is exchanged, e.g., a group for Product A, a group for Product B, etc. Some members among the members belonging to the workspace, belong to a channel. That is, the report destination is identified by a workspace and a channel. However, the method of identifying the report destination differs depending on the chat system, and, therefore, as long as there is identification information that can uniquely identify a group, this may be the only information used for the identification, or three or more pieces of information may be used for the identification.

A channel is guaranteed to be unique. Member accounts 1 to n are the accounts of the members of the channel, and these accounts are issued by the chat server 10. In the present embodiment, a bot is registered as a member to which information concerning the reservation in the conference room 6 is to be reported. The bot can be said to be an agent or a fictional member of the conference management server 30. The voice (text) of the bot is transmitted to the terminal apparatus 60 of the member accounts 1 to n.

The workspace and channels are managed by the conference management server 30 to provide information to identify a group to which the participant belongs.

### <<Conference Management Server>>

The conference management server 30 includes a communicating unit 31, an information associating unit 32, a reservation information acquiring unit 33, a report determining unit 34, a control information generating unit 35, a control information responding unit 36, a conference information reporting unit 37, a resource managing unit 38, an identification information registering unit 39, and a reservation information transmitting unit 40. Each of these functional units of the conference management server 30 is a function or means implemented by the elements illustrated in FIG. 4 operated in accordance with an instruction from the CPU 501 according to a program loaded from the HD 504 to the RAM 503. The program may be delivered from a program delivery server or distributed in a state of being stored in a storage medium.

The communicating unit 31 transmits and receives various kinds of information with the reservation management server 20, the chat server 10, the registration terminal 50, and the terminal apparatus 60. The communicating unit 31 includes a transmitting unit 31a and a receiving unit 31b. The receiving unit 31b receives reservation information from the reservation management server 20 and receives a request for reservation information from the conference room terminal 90. The receiving unit 31b receives a check-in request from the conference room terminal 90. The receiving unit 31b accepts the association between the group of the chat system and an account from the registration terminal 50 operated by the administrator. The transmitting unit 31a transmits the information concerning the reservation of the conference room to the chat server 10 and transmits the reservation information to the conference room terminal 90.

The information associating unit 32 mainly performs processes related to registration work in advance. That is, the information associating unit 32 accepts the registration of a domain from the registration terminal 50 operated by the administrator and the like, registers the domain in a customer domain DB 495, and registers the workspace and the channel of the chat system transmitted from the registration terminal 50 and the like and the account of the reservation management server 20 in association with other in an association information DB 491.

The reservation information acquiring unit 33 specifies the account of the customer using the resource reservation system 100 to acquire reservation information from the reservation management server 20, and registers the reservation information as the conference management information in a conference management information DB 493. Alternatively, the reservation information acquiring unit 33 receives reservation information for which a change has been made. Accordingly, at least a portion of the reservation information in the reservation management server 20 is stored in the conference management information DB 493. The reservation information acquiring unit 33 acquires reservation information for a predetermined future time period from the present, among the reservation information held by the reservation management server 20. The predetermined future time period will depend on how far ahead the conference is, for which information concerning the reservation of the conference room 6 is to be reported.

The report determining unit 34 determines whether there is a reservation of the start time that satisfies the condition of reporting in the conference management information. For example, by referring to a report setting DB 496, the report determining unit 34 determines that a report is to be transmitted when a set date and time approaches upon calculating backward from the start time of the reservation. Note when there are separate bots according to the role, for example, a bot for sending a reminder and a bot for accepting a reservation, a bot is identified according to the process.

The control information generating unit 35 generates control information of the electronic device 70 by referring to the conference management information and registers the control information in a control information DB 497. For example, several minutes prior to the start time of the conference, the control information generating unit 35 generates control information to turn on the power of the electronic device 70, and when check-out is detected, the control information generating unit 35 generates control information to turn off the power of the electronic device 70.

The control information responding unit 36 accepts a query as to whether there is control information from the conference room terminal 90 of the conference room 6, and upon referring to the control information DB 497, the control information responding unit 36 transmits the control information corresponding to the conference room 6 to the conference room terminal 90.

When the report determining unit 34 determines to transmit a report, the conference information reporting unit 37 specifies information identifying the bot (for example, a token in the case of slack) and information identifying the group that is the report destination, and requests the chat server 10 to report information concerning the reservation of the conference room 6. Note that transmission of the report is divided into several transmissions, but at least one piece of the divided report includes the conference identification information. The conference identification information is information for the conference management server 30 to confirm that the participant has the right to use the reserved conference room 6 during the reserved time period (identification information identifying the reservation of a resource). The conference information reporting unit 37 generates the conference identification information at least before the final piece of the divided report is transmitted. The conference identification information is registered in a conference identification information DB 494.

The resource managing unit 38 manages the check-in and check-out with respect to the conference room. Also, the resource managing unit 38 registers the status of the conference according to the check-in/check-out, in the conference management information DB 493. Check-in becomes acceptable 5 minutes to 10 minutes before the start time of the conference identified by the reservation ID (check-in waiting state). Then, when the pair of the conference room ID and the conference identification information transmitted by the conference room terminal 90 is registered in the conference identification information DB 494, the check in is allowed (check-in completed state).

As another check-in method, according to the present embodiment, it is determined whether the check-in is allowed based on whether the identification information of the terminal apparatus 60 is stored in a user account information DB 499 and the user name associated with the identification information of the terminal apparatus 60 matches the reserver account in the conference management information DB 493 that is in a check-in waiting state.

When the identification information of the terminal apparatus 60 is not registered in the user account information DB 499, the identification information registering unit 39 displays an input screen for inputting the conference identification information, on the conference room terminal 90. When the conference identification information is input, the identification information registering unit 39 searches for the conference identification information in the conference identification information DB 494, and identifies the reservation information in the conference management information DB 493 by the reservation ID or the conference room ID, and when the reservation information indicates a check-in waiting state in the conference management information DB 493, the identification information registering unit 39 registers the user name (reserver account) and the identification information of the terminal apparatus 60 in the user account information DB 499.

The reservation information transmitting unit 40 transmits reservation information (conference management information) stored in the conference management information DB 493 in response to a request from the conference room terminal 90. The reservation information transmitting unit 40 may transmit the reservation information in a JavaScript Object Notation (JSON) format, an eXtensible Markup Language (XML) format, a Comma-Separated Values (CSV) format, and the like. The reservation information is transmitted repeatedly, and, therefore, it is advantageous to use a format with little capacity.

The conference management server 30 includes a storage unit 49. The storage unit 49 is implemented by the RAM 503, the HD 504, and the like of FIG. 4. The storage unit 49 stores the association information DB 491, the conference management information DB 493, the conference identification information DB 494, the customer domain DB 495, the report setting DB 496, the control information DB 497, a conference room setting information DB 498, and the user account information DB 499.

TABLE 3
ASSOCIATION INFORMATION DB

| | | MEMBER | MEMBER | MEMBER | MEMBER |
|---|---|---|---|---|---|
| | | ACCOUNT | ACCOUNT | ACCOUNT | ACCOUNT |
| WORK SPACE | CHANNEL | 1 | 2 | 3 | 4 |
| http://sample.com/1 | #marketing | a@xfood.com | b@xfood.com | c@xfood.com | d@xfood.com |
| | | a@chat.com | b@chat.com | c@chat.com | d@chat.com |
| http://sample.com/2 | #team1 | f@xfood.com | g@xfood.com | h@xfood.com | |
| | | f@chat.com | g@chat.com | h@chat.com | |
| . . . | . . . | . . . | . . . | . . . | . . . |

Table 3 indicates an example of the association information stored in the association information DB 491. The association information is information for associating the account of the reservation management system, with the group of the chat system. The association information includes the items of a workspace, a channel, and member accounts 1 to n (n=4 in the table). The workspace and the channel are as described above. In each of the member accounts 1 to n, one participant's account issued by the reservation management server 20 is registered. Further, a chat system account may be registered as indicated in Table 3. In order to transmit a report to the group, it will suffice if there is information (in the present embodiment, the workspace and the channel name) for identifying the account in the reservation management server 20 of the user who has reserved a conference with respect to the reservation management server 20 and the group and the channel that is the report destination, and the accounts of all members belonging to the group need not necessarily be registered. However, when reporting to an individual user, the account information of each chat system is required, so the information may be registered as indicated in Table 3.

TABLE 4
CONFERENCE MANAGEMENT INFORMATION DB

| | | | | | | SCHEDULED | |
|---|---|---|---|---|---|---|---|
| RESERVATION | RESERVER | CONFERENCE | CONFERENCE | START | END | PARTICIPANT | |
| ID | ACCOUNT | NAME | ROOM ID | TIME | TIME | ACCOUNT | STATUS |
| 001 | a@xfood.com | ARTICLE Z | K-001 | 2017/07/07 | 2017/07/07 | b@xfood.com | CHECKED |
| | | DEVELOPMENT | | 10:00 | 12:00 | c@xfood.com | IN |
| | | CONFERENCE | | | | d@xfood.com | |
| 002 | e@xfood.com | ARTICLE Y | K-001 | 2017/07/07 | 2017/07/07 | f@xfood.com | REPORTED |
| | | DEVELOPMENT | | 13:00 | 14:00 | g@xfood.com | |
| | | CONFERENCE | | | | | |
| . . . | . . . | . . . | . . . | . . . | . . . | . . . | . . . |

Table 4 indicates an example of the conference management information stored in the conference management information DB 493 of the conference management server 30. The reservation information is stored in the conference management information DB 493, and, therefore, with reference to Table 4, the difference from the reservation information DB 291 in Table 1 is explained. The conference management information in Table 4 includes an item of a status. The status means the status of the reservation. For example, the statuses of information concerning the reservation of the conference room 6 reported, usage validated, checked in, waiting for check-in, checked-out, and cancelled, are registered.

TABLE 5
CONFERENCE IDENTIFICATION INFORMATION DB

| | | CONFERENCE |
|---|---|---|
| RESERVATION | CONFERENCE | IDENTIFICATION |
| ID | ROOM ID | INFORMATION |
| 001 | K-001 | 1234 |
| 002 | K-002 | 5678 |
| . . . | . . . | . . . |

Table 5 indicates an example of the conference identification information management information stored in the conference identification information DB 494. The conference identification information management information is information that manages the conference identification information for each reservation of the conference room 6. The conference identification information management information includes the items of a reservation ID, a conference room ID, and conference identification information. These are the same as the reservation information (the reservation information received from the reservation management server 20) except for the status, so descriptions of the same items are omitted. Note that the reservation ID is registered in order to identify reservations of the same conference room 6. Status means the status of the reservation. For example, the statuses of information concerning the reservation of the conference room 6 reported, usage validated, checked in, waiting for check-in, checked-out, and cancelled, are registered.

TABLE 6
CUSTOMER DOMAIN DB

| DOMAIN NAME | ADMINISTRATOR ACCOUNT |
|---|---|
| OF CUSTOMER | OF CUSTOMER |
| xfood.com | a@xfood.com |
| ycar.com | f@ycar.com |
| . . . | . . . |

Table 6 indicates an example of the customer domain information stored in the customer domain DB 495. Customer domain information is information that manages the customer's domain and the account of the customer's administrator. In the customer domain information, a customer domain name and a customer's administrator account are registered in association with each other. The customer domain in Table 6 is the domain of the account (e-mail address) issued by the reservation management server 20. The administrator account is the account of the customer's administrator (representing the customer). The account in Table 6 is issued by the reservation management server 20.

TABLE 7
REPORT SETTING DB

| DOMAIN NAME | |
|---|---|
| OF CUSTOMER | REPORT SETTING |
| xfood.com | ONE DAY BEFORE |
| ycar.com | 12 HOURS BEFORE |
| . . . | . . . |

Table 7 indicates an example of report setting information stored in the report setting DB 496. The report setting information holds a setting concerning reporting for each customer. In the report setting information, the customer domain name and the report setting are registered in association with each other. The report setting includes the timing of reporting the information concerning the reservation of the conference room 6, expressed by how long before the start time of the conference. Alternatively, a predetermined date and time may be set. Also, the timing does not need to be one timing; multiple report settings may be registered for one customer.

TABLE 8
CONTROL INFORMATION DB

| CONFERENCE ROOM ID | CONTROL CONTENT |
|---|---|
| K-001 | POWER ON |
| K-002 | POWER OFF |
| ... | . . . |

Table 8 indicates an example of control information stored in the control information DB 497. The control information is information for controlling the electronic device 70 in the conference room 6. The control information includes the items of a conference room ID and a control content. The control content is a specific control method of the electronic device 70. The conference management server 30 can set detailed control contents for each electronic device 70. Further, the time of control is not registered because it is difficult to transmit information from the conference management server 30 of the external network to the conference room terminal 90; thus, the conference room terminal 90 accesses the conference management server 30, and at this time, if the control information is generated, the control contents are transmitted.

TABLE 9
CONFERENCE ROOM SETTING INFORMATION DB

| | | | | | | NUMBER OF |
|---|---|---|---|---|---|---|
| | | | | | | CONFERENCE |
| | | | STATE OF | | | ROOM TERMINALS |
| CUSTOMER | CONFERENCE | CONFERENCE | CONFERENCE | AUTHENTICATION | MANAGEMENT | THAT CAN BE |
| ID | ROOM NAME | ROOM ID | ROOM TERMINAL | KEY | START FLAG | REGISTERED |
| G-001 | CONFERENCE | K-001 | CONNECTED | ***** | True | 1 |
| | ROOM A | | | | | |
| | CONFERENCE | K-002 | BEFORE | ***** | False | 1 |
| | ROOM B | | SETUP | | | |
| | CONFERENCE | K-003 | DISCONNECTION | ***** | True | 2 |
| | ROOM C | | | | | |

Table 9 indicates an example of the conference room setting information stored in the conference room setting information DB 498. The conference room setting information is information concerning the setting for each conference room. In the conference room setting information, the items of a conference room name, a conference room ID, the state of the conference room terminal 90, an authentication key, a management start flag, and the number of the conference room terminals 90 that can be registered, are stored in association with a customer ID.
The conference room name is a general name of the conference room that the participants of the conference are aware of, and is presented, for example, at the entrance to the conference room.
The conference room ID is the identification information that uniquely identifies the conference room as described above. In a simplified case, the conference room ID may be common to that of the reservation management server 20. However, a conversion table may be provided so that an administrator can separately set a conference room ID that is different from that of the reservation management server 20.
The state of the conference room terminal 90 indicates whether the initial setting of the conference room terminal 90 has been completed, whether communication is possible, and the like.
   Connected: A state in which communication is confirmed within a certain period of time.
   Before setup: Before initial setting.
   Disconnection: A state in which there is no communication for more than a certain period of time.
The authentication key is the authentication information for authenticating the conference room terminal 90 by the conference management server 30. The authentication key is transmitted to the conference room terminal 90 according to the initial setting. An authentication key is a combination of numbers, alphabetical letters, symbols, etc., including a sufficiently large number of digits so as not to be identified by a brute-force method. The authentication key may be determined by the conference management server 30 or by an administrator.
The management start flag is a flag (True: start, False: do not start) indicating whether the management of the conference room is to be started by the conference management server 30 after the initial setting of the conference room terminal 90 is completed. Because there is a management start flag, it is possible to reduce the inconvenience caused by the time lag from the completion of the initial setting to the arrangement of the conference room terminal 90. Details will be given below.
The number of the conference room terminals 90 that can be registered is the number of the conference room terminals 90 that can be associated with one conference room. It will suffice as long as there is one conference room terminal 90 in a single conference room. However, when an abnormality occurs in the conference room terminal 90, it is difficult to check in to the conference room while the conference room terminal 90 is being repaired. For this reason, the administrator may wish to associate multiple conference room terminals 90 with a single conference room. Accordingly, even if the authentication key is leaked to the outside, the terminal ID matches and the number of terminal IDs is fixed, and, therefore, it is possible to prevent the reservation information from leaking to the outside. The initial value may be 1 or more.

The conference room name and the conference room ID are predetermined, but may be set by the administrator. A conference room name sent from the reservation management server 20 may be used. The initial state of the conference room terminal 90 (immediately after the setting by the provider) is before setup, but the state transitions depending on the communication status. A value of the authentication key is set by, for example, the conference management server 30 at the time of the initial setting. The management start flag is set by the administrator from the setting screen described later. The number of the conference room terminals 90 that can be registered can also be set by the administrator. The number of the conference room terminals 90 that can be registered is often one or more. When the number of the conference room terminals 90 that can be registered is set to 1, only one conference room terminal 90 can be registered in one conference room.

TABLE 10

| | IDENTIFICATION INFORMATION |
|---|---|
| USER NAME | OF TERMINAL APPARATUS |
| a@xfood.com | 11223344 |
| e@xfood.com | 00445969 |
| . . . | . . . |

Table 10 indicates an example of user account information stored in the user account information DB 499. The user account information includes the items of a user name and identification information of the terminal apparatus 60. The user name is transferred from the reserver account in the conference management information DB 493. In some cases, the scheduled participant account is registered as the user name. The identification information of the terminal apparatus 60 is identification information for uniquely identifying the terminal apparatus 60. For example, a UUID, a Media Access Control (MAC) address, an e-mail address, etc., may be used. In the case of a UUID, the identification information can be referred to as the identification information of the conference application, and in the sense that the identification information is unique to the user, the identification information can be referred to as the user identification information. The MAC address and the e-mail address also have the meaning of user identification information in addition to identification information of the terminal apparatus 60. Biological information such as fingerprints and the like may be registered by the user as identification information of the terminal apparatus 60.

### <<Registration Terminal>>

The registration terminal 50 includes a communicating unit 51, an operation accepting unit 52, and a display control unit 53. Each of these functional units included in the registration terminal 50 is a function or means implemented by one of the elements illustrated in FIG. 4 operating according to an instruction from the CPU 501 according to a program loaded from the HD 504 to the RAM 503. The program may be delivered from a program delivery server or distributed in a state of being stored in a storage medium.

The registration terminal 50 is a terminal for performing various settings related to the conference room by the administrator through a web page provided by the conference management server 30. One of these settings is the initial setting. The terminal apparatus 60 may be used for the initial setting. The functions of the communicating unit 51, the operation accepting unit 52, and the display control unit 53 of the registration terminal 50 are the same as those of the terminal apparatus 60, and will be described in detail together with the terminal apparatus 60.

### <<Terminal Apparatus>>

FIG. 7 is an example of a functional block diagram illustrating functions of the terminal apparatus 60 and the conference room terminal 90 in a block shape. The functions of the electronic device 70 will be described as needed.

The terminal apparatus 60 includes a communicating unit 61a, an operation accepting unit 61b, a display control unit 61c, a chat communicating unit 62, a text display unit 63, an application communicating unit 64, a server communicating unit 65, a display control unit 66, an application communicating unit 67, and a terminal communicating unit 68. Each of these functional units of the terminal apparatus 60 is a function or means that is implemented by each of the elements illustrated in FIG. 4 being operated by an instruction from the CPU 501 according to programs loaded from the HD 504 to the RAM 503. The programs may be delivered from a program delivery server or distributed in a state of being stored in a storage medium. A chat application 60a and a conference application 60b are operated in the terminal apparatus 60, and, therefore, the programs include the chat application 60a and the conference application 60b.

The communicating unit 61a transmits and receives various kinds of information with the conference management server 30 and the reservation management server 20. The operation accepting unit 61b accepts various operations of the participant with respect to the terminal apparatus 60.

The display control unit 61c interprets screen information of various screens and displays the screen information on the display 506. The operation accepting unit 61b and the display control unit 61c have, for example, browser functions and can execute a web application. For example, a reservation setting screen received from the reservation management server 20 is displayed, and the operation accepting unit 61b receives the reservation information set by the reserver.

The chat communicating unit 62 of the chat application 60a transmits and receives various kinds of information with the chat server 10. According to the present embodiment, the information concerning the reservation of the conference room 6 is received from the chat server 10, and the chat communicating unit 62 reports, to the chat server 10, the fact that the information has already been read, whether the conference room 6 will be used or cancelled, and the like.

The text display unit 63 of the chat application 60a displays the text (information concerning the reservation of the conference room 6) transmitted from the chat server 10. For example, the voice source is a bot and the text is displayed as if the bot has input the text.

The application communicating unit 64 of the chat application 60a calls the conference application 60b and transmits the conference identification information to the conference application 60b. The chat server 10 has transmitted the information identifying the conference application 60b to the terminal apparatus 60 when reporting the information concerning the reservation of the conference room 6. Therefore, the chat application 60a specifies the conference application 60b and requests the OS to report the conference identification information. The OS can activate the conference application 60b.

The server communicating unit 65 of the conference application 60b communicates with the conference management server 30. A two-dimensional code including the conference identification information based on the information acquired from the chat application 60a, is acquired from the conference management server 30 and the like. The two-dimensional code may be used for causing the conference room terminal 90 to capture an image when performing authentication at the time of check-in instead of inputting conference identification information by a user. The display control unit 66 of the conference application 60b displays a two-dimensional code including the conference identification information, the conference identification information itself, and the like on the display 506. The application communicating unit 67 of the conference application 60b acquires various kinds of information (such as conference identification information included in the information concerning the reservation of the conference room 6) from the chat application 60a via the OS.

The terminal communicating unit 68 communicates with the conference room terminal 90 and transmits the conference identification information or identification information 691 of the terminal apparatus 60 stored in a storage unit 69. The terminal communicating unit 68 detects the presence of the conference room terminal 90 by short-range wireless communication such as Bluetooth (registered trademark), Near Field Communication (NFC), infrared rays, and visible optical communication, and upon detecting the conference room terminal 90, the terminal communicating unit 68 transmits conference identification information or identification information of the terminal apparatus 60.

### <<Conference Room Terminal>>

The conference room terminal 90 includes a server communicating unit 91, a terminal apparatus communicating unit 92, an operation accepting unit 93, a display control unit 94, an electronic device communicating unit 95, a terminal authenticating unit 96, an imaging unit 97, a decoding unit 98, a setting recording unit 98-2, and a reservation information requesting unit 98-3. Each of these functions included in the conference room terminal 90 is a function or means implemented by each of the elements illustrated in FIG. 5 being operated by an instruction from the CPU 401 according to a program loaded from the EEPROM 404 to the RAM 403. The program may be delivered from a program delivery server or distributed in a state of being stored in a storage medium.

The server communicating unit 91 communicates with the conference management server 30 by specifying a server URL 993 as the destination. The conference room terminal 90 is present in the internal network, and, therefore, it is difficult to communicate with the conference room terminal 90 from the conference management server 30. For this reason, the server communicating unit 91 communicates with the conference management server 30 by a communication technology such as polling (regularly communicating with the conference management server 30) or WebSocket. When there is no communication from the server communicating unit 91, disconnection is registered in the conference room setting information DB 498. The server communicating unit 91 may communicate by a communication protocol such as HyperText Transport Protocol (HTTP), and the communication protocol is not particularly limited.

The server communicating unit 91 according to the present embodiment receives the reservation information and transmits the conference identification information received by the terminal apparatus communicating unit 92 from the terminal apparatus 60, the manually input conference identification information, or the identification information of the terminal apparatus, to the conference management server 30 at the time of checking in. In some cases, the server communicating unit 91 receives the control information from the conference management server 30.

The terminal apparatus communicating unit 92 communicates with the terminal apparatus 60. In the present embodiment, the conference identification information and the identification information of the terminal apparatus 60 and the like are received.

The electronic device communicating unit 95 communicates with the electronic device 70. In the present embodiment, the control information received by the server communicating unit 91 is transmitted to the electronic device 70.

The display control unit 94 displays a screen generated by a terminal application 90a on the display 418. This screen is a standby screen where check-in, check-out and the like are possible. The input screen of the conference identification information may be displayed. The operation accepting unit 93 accepts various operations with respect to the conference room terminal 90.

The terminal authenticating unit 96 authenticates the administrator's login to the terminal application based on whether the input administrator password is correct. The conference room terminal 90 located in the conference room is operable by an unspecified participant, and therefore, the initial setting may be changed if there is no authentication function.

The imaging unit 97 mainly captures the QR code (registered trademark; hereafter omitted). When the conference room terminal 90 is operated so that the QR code (the QR code for the initial setting or the QR code of the conference identification information) acquired from the conference management server 30 and displayed by the registration terminal 50 is within the angle of view of the CMOS sensor 413, the imaging unit 97 recognizes the QR code and automatically generates image data. The decoding unit 98 decodes the QR code captured by the imaging unit 97 and restores the communication setting information or the conference identification information described below. The QR code for the initial setting is acquired from the conference management server 30 and displayed by the registration terminal 50, and includes information of the conference room setting information DB 498.

The setting recording unit 98-2 stores the communication setting information (the conference room ID, the authentication key, the server URL, and the conference room name) decoded by the decoding unit 98 in a storage unit 99.

The reservation information requesting unit 98-3 repeatedly transmits the conference room ID and the authentication key to the conference management server 30 via the server communicating unit 91 at a periodic timing for acquiring the reservation information. As a response, the reservation information requesting unit 98-3 acquires the reservation information via the server communicating unit 91. It is sufficient to acquire the reservation information only when a change is made. The timing occurs at a cycle of every few seconds to every few minutes. The shorter the cycle, the earlier the reservation information can be updated, but the communication load will increase, so the cycle is determined in consideration of both the speed and load. In the present embodiment, for example, the cycle is 30 seconds. At least the conference management information (reservation information) of the conference room 6 of the present day can be received via the server communicating unit 91.

The conference room terminal 90 includes the storage unit 99. The storage unit 99 is implemented by the ROM 402, the EEPROM 404, and the like of FIG. 5. The storage unit 99 stores a conference room ID 991, an authentication key 992, the server URL 993, a conference room name 994, a terminal ID 995, an administrator password 996, and an Internet Protocol (IP) address 997 of the electronic device 70.

The terminal ID 995 is the identification information of the conference room terminal 90. The terminal ID is used by the conference management server 30 to identify the conference room terminal 90, in order to prevent the connection of more than a predetermined number of the conference room terminals 90 determined in advance for each conference room, from being connected to the conference management server 30. For example, the terminal ID is to be unique, such as a UUID (Universally Unique Identifier) of the terminal application and a MAC address. A UUID is a unique identifier such that two or more items will not have the same value worldwide without specific management.

The administrator password 996 is set by the administrator at the time of installation or the first time of activating the terminal application 90a. The IP address 997 of the electronic device 70 is set by the administrator as needed.

### <Operation or Process of Reservation Information Registration>

Next, the procedure for reserving a conference room by the reserver will be described with reference to the above configurations and FIG. 8. FIG. 8 is an example of a sequence diagram illustrating the steps from the reservation of a conference room to the display of a standby screen.

S1: The reserver operates the terminal apparatus 60 to connect to the reservation management server 20 and undergoes authentication using the user information DB 292. When the authentication is successful, the reserver reserves the conference room upon setting the start time, the end time, the conference room, the conference name, etc., of the conference with a predetermined web page or an exclusive-use application. The communicating unit 61a of the terminal apparatus 60 transmits the reservation information including the above items to the reservation management server 20.

S1.1: The communicating unit 21 of the reservation management server 20 receives the reservation information and the reservation information managing unit 22 registers the reservation information in the reservation information DB 291.

S1.2: The communicating unit 21 of the reservation management server 20 reports, to the conference management server 30, about any change that is made in the reservation information together with the domain of the reserver.

S1.3: The reservation information acquiring unit 33 of the conference management server 30 specifies a domain that identifies a customer, and requests the reservation management server 20 to provide the reservation information (including the license information of the conference management server 30 for authentication), periodically or in response to a report from the reservation management server 20.

S1.4: The communicating unit 21 of the reservation management server 20 receives the request, and transmits, to the conference management server 30, the reservation information of the reserver having the specified domain, acquired by the reservation information managing unit 22 from the reservation information DB 291.

S1.5: The reservation information acquiring unit 33 of the conference management server 30 acquires the reservation information and registers the reservation information in the conference management information DB 493. The reservation information acquiring unit 33 issues conference identification information for each piece of reservation information acquired and registers the conference identification information in the conference identification information DB 494.

S1.6: The conference information reporting unit 37 of the conference management server 30 detects a reserver or a participant in the association information DB 491, identifies the information identifying a group in the chat server 10, and reports, to the chat server 10, a message indicating that the reservation is completed (including the conference identification information). Accordingly, the text processing unit 12 of the chat server 10 reports, to the group (the channel of the workspace) identified by the information identifying the group, the conference identification information in a synchronous manner. The reservation information is preferably included. The reporting may be performed by e-mail. At the time of checking in to the conference room terminal 90, the reserver or participant inputs the conference identification information as necessary.

S2: The reservation information requesting unit 98-3 of the conference room terminal 90 specifies the authentication key 992 and the conference room ID 991 and requests the conference management server 30 to provide the reservation information by setting the server URL 993 as the destination, periodically or in response to the operation of the participant. The receiving unit 31b of the conference management server 30 receives the request and, when the pair of the authentication key and the conference room ID is registered in the conference room setting information DB 498, the receiving unit 31b acquires the reservation information of the conference room identified by the conference room ID (the conference management information) from the conference management information DB 493 and transmits the reservation information to the conference room terminal 90.

S3: The server communicating unit 91 of the conference room terminal 90 receives the reservation information, and the display control unit 94 displays the reservation information on the standby screen. Examples of the standby screen are illustrated in FIGS. 9 to 11.

### <Standby Screen>

The reservation information displayed by the conference room terminal 90 will be described with reference to FIGS. 9 to 11.

FIG. 9 illustrates an example of a standby screen I displayed by the conference room terminal 90 when the conference room is presently vacant. The standby screen I of FIG. 9 displays a present status field 561, a conference room name field 562, a conference name field 563, a start time field 564, an end time field 565, a use start button 566, and a subsequent reservation field 567.

The present status field 561 indicates the present status of the conference room. The display control unit 94 of the conference room terminal 90 displays the status of the reservation information in the present status field 561. When there is no reservation information of a reservation at the present time, the display control unit 94 displays “vacant room” (until check-in of the next reservation becomes possible) or “waiting for entry” (after check-in of the next reservation has become possible) in the present status field 561.

The conference room name stored in the storage unit 99 is displayed in the conference room name field 562. The conference name included in the reservation information is displayed in the conference name field 563. Until check-in of the next reservation becomes possible, the display control unit 94 displays “no reservation” in the conference name field 563.

The start time and end time included in the reservation information are displayed in the start time field 564 and the end time field 565, respectively. FIG. 9 illustrates the standby screen of a time period without any reservation, and, therefore, the end time of the last conference is displayed in the start time field 564 and the start time of the next conference is displayed in the end time field 565.

The subsequent reservation field 567 displays the start time and end time of each conference that is reserved later than the present, according to the reservation information. The use start button 566 is displayed when the present status field 561 is displaying “vacant room”. The user can start using the conference room by pressing the use start button 566 without having to reserve a conference room. The pressing of this button is transmitted to the reservation management server 20 via the conference management server 30 to generate reservation information and change the status of the conference room. The status change is also reflected on the standby screen when the conference room terminal 90 receives reservation information.

FIG. 10 illustrates an example of a standby screen II displayed by the conference room terminal 90 when a conference room is presently vacant but the present time is within a predetermined time until the next conference starts. In the standby screen II of FIG. 10, the present status field 561 displays “waiting for entry” and an entry button 568 is displayed. Waiting for entry corresponds to waiting for check-in. Further, the reserver is displayed in a reserver name field 570. When the status of the reservation information changes to “waiting for check-in” and the like, the display control unit 94 displays “waiting for entry” and displays the entry button 568.

For example, when the present time becomes 10 minutes before the start time, the status changes to “waiting for check-in” and the like. Therefore, the display control unit 94 displays “waiting for entry” and allows check-in. That is, it becomes possible for the reserver to check in. Further, if the conference room terminal 90 does not transmit a check-in request by a predetermined time, the resource managing unit 38 of the conference management server 30 determines that check-in is not detected and automatically cancels the reservation. Therefore, the display control unit 94 counts down a time 569 until the automatic cancellation and displays the time in the present status field 561. The time until the reservation is automatically cancelled, for example, is 10 minutes after the start time.

The entry button 568 is a button for the user to check in. By pressing this button, the reserver can input the conference identification information. A message 572 is displayed below the entry button 568, stating “please pass the smart device over the right side of the conference room terminal 90”. At the time of waiting for entry, the reserver can pass the terminal apparatus 60 over the conference room terminal 90 instead of inputting the conference identification information. The identification information of the terminal apparatus 60 is transmitted to the conference room terminal 90. Alternatively, when the entry button 568 is pressed, the conference room terminal 90 may start communication with the terminal apparatus 60.

Reserver information is displayed in the reserver name field 570. The reserver may be an account included in the reservation information, or the reserver's name or nickname may be transmitted from the conference management server 30. It is also possible to display a photo of the reserver or a character that represents the reserver.

FIG. 11 illustrates an example of a standby screen III displayed by the conference room terminal 90 when the conference room is presently in use. In the standby screen III of FIG. 11, the present status field 561 indicates “in use” (indicating that the conference is presently being used), and an exit button 571 is displayed. When the reserver inputs the conference identification information or passes over the terminal apparatus 60 and the conference management server 30 allows the check-in, the status of the conference management information DB 493 becomes “checked in”. When the conference room terminal 90 receives the reservation information, the display control unit 94 detects that the status has become checked in. The display control unit 94 displays the present status field 561 as “in use” and displays the exit button 571 until the check-out. The display control unit 94 counts down the time until the end time and displays this time in the present status field 561. The exit button 571 is a button for the reserver to check out. When this button is pressed, a check-out request is transmitted to the conference management server 30, and the resource managing unit 38 of the conference management server 30 updates the status of the conference management information DB 493 to “checked out”. When the conference room terminal 90 receives the reservation information, the display control unit 94 displays “vacant room” or “waiting for entry” in the present status field 561.

Note that the information displayed in FIGS. 9 to 11 may not be generated by the conference room terminal 90 based on the reservation information, but may be generated by the conference management server 30 and displayed by the conference room terminal 90. In this case, the conference room terminal 90 executes browser software, so that the conference management server 30 can control the entire standby screen of the conference room terminal 90.

### <Check-in Using Identification Information of Terminal Apparatus>

Next, a procedure in which the reserver or participant checks in to the conference room terminal 90 using the identification information of the terminal apparatus 60 will be described with reference to FIG. 12. FIG. 12 is an example of a sequence diagram illustrating a process or an operation when the reserver or the participant transmits identification information of the terminal apparatus 60 to the conference room terminal 90 and checks in.

S11: As illustrated in FIG. 11, it is assumed that the conference room terminal 90 is in the state of waiting for entry. The stand-by screen II is displayed.

S12: The reserver or participant operates the terminal apparatus 60 to activate the conference application 60b and display a screen for check-in.

S13: When displaying the screen for checking in, and when the terminal communicating unit 68 of the terminal apparatus 60 has not generated the identification information of the terminal apparatus 60, the terminal communicating unit 68 generates the identification information of the terminal apparatus 60 and stores the identification information in the storage unit 69. The identification information of the terminal apparatus 60 will be stored in the storage unit 69 once generated, and, therefore, it is not necessary to generate the identification information at the next time of displaying the screen.

S14: The reserver or participant passes the terminal apparatus 60 over the conference room terminal 90 (brings the terminal apparatus 60 near the conference room terminal 90).

S15: The terminal apparatus 60 and the conference room terminal 90 start communication, and the terminal communicating unit 68 transmits identification information of the terminal apparatus 60 to the conference room terminal 90. Therefore, the terminal communicating unit 68 can transmit the identification information of the terminal apparatus 60 to the conference room terminal 90 without receiving the user's manual input of information.

S16: The terminal apparatus communicating unit 92 of the conference room terminal 90 receives the identification information of the terminal apparatus 60, and the server communicating unit 91 transmits, to the conference management server 30, the identification information of the terminal apparatus 60, the conference room ID, and the reservation ID (the reservation ID of the reservation information indicating waiting for check-in) for requesting authentication using the identification information of the terminal apparatus 60 (equivalent to a check-in request).

First, the case in which the identification information of the terminal apparatus 60 is not stored in the user account information DB 499 will be described. The resource managing unit 38 of the conference management server 30 searches for the identification information of the terminal apparatus 60 in the user account information DB 499 and, if the identification information is not found, the resource managing unit 38 returns a report of authentication unsuccessful (the device identifier is not registered) to the conference room terminal 90. The details of this process will be described with reference to FIG. 16.

S17: The server communicating unit 91 of the conference room terminal 90 receives the report of authentication unsuccessful, and, therefore, the terminal apparatus communicating unit 92 temporarily stores the identification information of the terminal apparatus 60 in the storage unit 99.

S18: Next, the display control unit 94 displays an input screen for inputting the conference identification information. An example of an input screen is illustrated in FIG. 13.

S19: The reserver or participant inputs the conference identification information reported from the chat server 10 and the like into the input screen. The operation accepting unit 93 of the conference room terminal 90 accepts the conference identification information. The terminal apparatus 60 may transmit the conference identification information wirelessly to the conference room terminal 90.

S20: The server communicating unit 91 of the conference room terminal 90 specifies the input conference identification information and the identification information of the terminal apparatus 60 stored therein and transmits a verification request (equivalent to the check-in request) of the conference identification information to the conference management server 30.

S21: The receiving unit 31b of the conference management server 30 receives the conference identification information and the identification information of the terminal apparatus 60, and verifies the conference identification information received by the identification information registering unit 39. Details are described in FIG. 17.

S22: When it is successfully verified that that the conference identification information is valid, the identification information registering unit 39 registers the identification information of the terminal apparatus 60 and the reserver account (in the case of a participant, the participant account) acquired from the conference management information DB 493, in association with each other in the user account information DB 499.

S23: Because the conference identification information has been verified, the resource managing unit 38 changes the state of the conference room ID and the reservation information of conference that is in a state of waiting for check-in, to a checked in state. That is, check-in is allowed. The transmitting unit 31a of the conference management server 30 transmits a report of verification successful (and hence is a report of check-in successful) to the conference room terminal 90.

S24: The server communicating unit 91 of the conference room terminal 90 receives the report of the verification successful, and the display control unit 94 changes the display to the standby screen III. The display may be changed upon receipt of the reservation information that has been changed to checked in.

S25: On the other hand, when the conference identification information cannot be verified as being valid (verification unsuccessful), the transmitting unit 31a of the conference management server 30 transmits a report of verification unsuccessful to the conference room terminal 90.

S26: Because the conference room terminal 90 has received a report of verification unsuccessful, the display control unit 94 displays the input screen of the conference identification information again and waits for the reserver or participant to input the correct conference identification information.

Next, the case in which the identification information of the terminal apparatus 60 is stored in the user account information DB 499 will be described.

S27: The resource managing unit 38 of the conference management server 30 searches for the identification information of the terminal apparatus 60 in the user account information DB 499 and, when the identification information is found, the resource managing unit 38 identifies the user name. The resource managing unit 38 identifies the reservation information which has this user name in the reserver account or the scheduled participant account in the conference management information DB 493 and, if the reservation information is in the state of waiting for check-in, the resource managing unit 38 changes the state of the reservation information to the checked in state. Accordingly, the resource managing unit 38, which determines whether to allow the use of the conference room depending on whether the conference identification information has been transmitted from the conference room terminal 90, can determine whether to allow the use of the conference room based on the identification information of the terminal apparatus 60, even without the conference identification information being transmitted from the conference room terminal 90.

S28: The transmitting unit 31a of the conference management server 30 transmits a report of check-in successful to the conference room terminal 90.

S29: The server communicating unit 91 of the conference room terminal 90 receives the report of check-in successful, and the display control unit 94 changes the display to the standby screen III. The display may be changed upon receiving the reservation information that has been changed to checked in.

### <<Input Screen of Conference Identification Information>>

FIG. 13 is an example of an input screen 300 for inputting the conference identification information, displayed by the conference room terminal 90. The input screen 300 for inputting the conference identification information includes an input field 301 for inputting the conference identification information and a transmission button 302. When the reserver inputs the conference identification information and presses the transmission button 302, the operation accepting unit 93 accepts the conference identification information and the server communicating unit 91 transmits the conference identification information to the conference management server 30.

### <<Transition of Screen Displayed by Terminal Apparatus>>

The transition of the screen displayed by the terminal apparatus 60 will be described with reference to FIGS. 14A to 15B. First, FIG. 14A illustrates a home screen 310 displayed by the terminal apparatus 60, in which a list of applications including an icon 311 of the conference application 60b is displayed.

FIG. 14B illustrates a check-in screen 320 displayed when the conference application 60b is activated. For example, this check-in screen 320 is displayed in step S12 of FIG. 12. The check-in screen 320 includes a message 321 of “check-in to conference room”, a thumbnail 325 of the standby screen, a message 322 of “you can check-in to (enter) that conference room by passing a smart device over the conference room terminal”, a setting button 324, and a next button 323. Accordingly, the user can recognize that the terminal apparatus 60 is to be passed over the conference room terminal 90. When the user presses the next button 323, a searching screen 330 of FIG. 15A is displayed.

FIG. 15A illustrates an example of the searching screen 330. For example, the searching screen 330 is displayed in step S14 of FIG. 12. The searching screen 330 includes a message 331 stating “searching for conference room terminal” and a cancel button 332. The terminal apparatus 60 starts searching for the conference room terminal 90 when the next button 323 in FIG. 14B is pressed. Searching means to determine whether a Bluetooth Low Energy (registered trademark) advertisement packet can be received and the ID registered in the conference application 60b can be received. When the terminal apparatus 60 starts communication with the conference room terminal 90, the screen transitions to the in-communication screen of FIG. 15B.

FIG. 15B illustrates an example of an in-communication screen 340. For example, the in-communication screen 340 is displayed in step S15 of FIG. 12. The in-communication screen 340 is a screen indicating that the terminal apparatus 60 is in communication with the conference room terminal 90. In this state, the identification information of the terminal apparatus 60 is transmitted from the terminal apparatus 60 to the conference room terminal 90. When communication is completed, the display returns to the check-in screen 320 in FIG. 14B.

<Process or Operation of Conference Management Server that has Received Identification Information of Terminal Apparatus>>

FIG. 16 is an example of a flowchart illustrating the process or operation of the conference management server 30 that has received the identification information of the terminal apparatus 60. As described in FIG. 12, in step S16, the identification information of the terminal apparatus, the conference room ID, and the reservation ID are transmitted to the conference management server 30.

The resource managing unit 38 searches the user account information DB 499 by the identification information of the terminal apparatus 60, and identifies the user name (step S101).

When the identification information of the terminal apparatus 60 is not registered in the user account information DB 499, the resource managing unit 38 transmits a report of authentication unsuccessful (the device identifier is not registered) to the conference room terminal 90 (step S102). In this case, the process proceeds to the registration process of the identification information of the terminal apparatus 60.

When the identification information of the terminal apparatus 60 is registered in the user account information DB 499, the resource managing unit 38 identifies the reservation information in the check-in waiting state among the reservation information in the conference management information DB 493 for which the user name identified in the user account information DB 499 is used as the reserver account (step S103). It is also possible to allow a participant, for which the user name identified in the user account information DB 499 is used as the scheduled participant account, to check in.

When the reservation information cannot be identified, for example, when the reserver that is the same as the user name cannot be identified or the reservation information is not in the check-in waiting state, the resource managing unit 38 transmits a report of identification unsuccessful (no conference being reserved) to the conference room terminal 90 (step S104). In this case, a message including the aforementioned report is displayed on the conference room terminal 90, so that it is understood that the user has not made a reservation at the present time (i.e., there is no need to check in).

When the reservation information in the check-in waiting state, among the reservation information in the conference management information DB 493 for which the user name identified in the user account information DB 499 is used as the reserver account, can be identified in the conference management information DB, the resource managing unit 38 changes the state of the reservation information identified in step S103, to a checked state (step S105).

The transmitting unit 31a of the conference management server 30 transmits a report of authentication successful (check-in successful) to the conference room terminal 90 (step S106).

Note that there may be a case where the reservation management server 20 has allowed the same user to reserve a plurality of conference rooms for the same time period. In this case, in step S103, a plurality of pieces of reservation information may be identified. However, the conference room terminal 90 transmits the conference room ID or the reservation ID together with the identification information of the terminal apparatus to the conference management server 30, and, therefore, the conference management server 30 can identify the reservation information that is in the state of waiting for check-in.

### <<Registration Process of Identification Information of Terminal Apparatus>>

FIG. 17 is an example of a flowchart illustrating a process or an operation in which the conference management server 30 that has received the conference identification information registers the identification information of the terminal apparatus 60. As described in FIG. 12, the conference identification information and the identification information of the terminal apparatus have been transmitted to the conference management server 30 in step S20.

First, the identification information registering unit 39 determines whether the conference identification information received from the conference room terminal 90 is registered in the conference identification information DB 494. When the conference identification information is registered, the identification information registering unit 39 acquires the conference room ID associated with the conference identification information, and identifies the reservation information reserved by the conference room ID in the conference management information DB 493 (step S201). There may be cases where a plurality of pieces of reservation information are registered by the same conference room ID, and, therefore, the identification information registering unit 39 identifies the reservation information in the state of waiting for check-in. From this reservation information, the identification information registering unit 39 acquires the reservation account.

When the reserver account cannot be acquired (the conference identification information is not registered, there is no reservation information in the state of waiting for a check-in), the reserver cannot be presumed to be the reserver who has reserved the conference room, and, therefore, the transmitting unit 31a of the conference management server 30 transmits a report of verification unsuccessful to the conference room terminal 90 (step S202).

When the reserver account can be acquired, the reserver can be presumed to be the reserver who has reserved the conference room for the present time period. Therefore, the identification information registering unit 39 of the conference management server 30 registers the identification information of the terminal apparatus 60 and the reserver account (user name) acquired from the conference management information DB 493 in association with each other, in the user account information DB 499 (step S203).

Accordingly, when the reserver inputs the conference identification information in the conference room that is in the state of waiting for check-in, the identification information of the terminal apparatus 60 held by the reserver can be registered in the conference management server 30, and at the next time of checking in, the reserver can check-in simply by passing the terminal apparatus 60 over the conference room terminal 90.

In the user account information DB 499, a plurality of pieces of identification information of the terminal apparatuses 60 may be registered for one user, or only one piece of identification information of the terminal apparatus 60 may be registered for one user (overwritten and updated each time).

### <Registration of Identification Information of Terminal Apparatus by User Operation>

FIG. 17 illustrates a method of registering the identification information of the terminal apparatus 60 at the timing of checking in. However, the identification information of the terminal apparatus 60 can be registered at any timing by a user. First, the transition of the screen displayed by the terminal apparatus 60 will be described.

FIG. 18 is a diagram illustrating an example of the screen transition when the user registers the identification information of the terminal apparatus 60 to the conference management server 30 at any time. FIG. 18 (a) illustrates the same check-in screen 320 as that of FIG. 14B. In the check-in screen 320 in FIG. 14B, the user presses the setting button 324. Accordingly, a selection menu screen 350 illustrated in FIG. 18 (b) is displayed.

FIG. 18 (b) illustrates an example of the selection menu screen 350. The selection menu screen 350 includes a registration button 351 for registering the authentication information and a shortcut creation button 352. The registration button 351 for registering the authentication information is for registering the identification information of the terminal apparatus 60 and the user name, and the shortcut creation button 352 is for creating a shortcut, which is for accessing only the conference room terminal authentication function, on the home screen. When the registration button 351 is pressed, the screen transitions to an authentication information input screen 360 illustrated in FIG. 18 (c).

FIG. 18 (c) is an example of the authentication information input screen 360. The authentication information input screen 360 includes a server name field 361, a port number field 362, a user name field 363, a password field 364, and a registration button 365. In the server name field 361, the domain name (host name) and IP address of the conference management server 30 are input. In the port number field 362, for example, 80 for HTTP communication or 443 for HTTPs may be input. In the user name field 363, the identification information of the same user as the reserver account is input. In the password field 364, information for the conference management server 30 to authenticate a user is input.

When the registration button 365 is pressed, the identification information of the terminal apparatus 60, the user name, and the password are transmitted to the conference management server 30. The conference management server 30 includes the same user information as that in Table 1B. When authentication is successful, the identification information registering unit 39 registers the identification information of the terminal apparatus 60 and the user name in the user account information DB 499.

The user may have the conference management server 30 transmit an e-mail to his/her mail address, access the URL described in the e-mail, and input the user name and password. In this case also, when authentication is successful, the identification information registering unit 39 registers the identification information of the terminal apparatus 60 and the user name in the user account information DB 499.

### <<Process or Operation of Information Processing Apparatus>>

FIG. 19 is an example of a flowchart illustrating a registration process performed by the information processing apparatus that has received the identification information of the terminal apparatus 60, the user name, and the password.

The identification information registering unit 39 authenticates the user based on the user name and the password (step S301). The identification information registering unit 39 determines whether the user name and the password are stored in a DB similar to the user information DB 292 (step S302).

When authentication is unsuccessful, the identification information registering unit 39 transmits a message reporting an error to the terminal apparatus 60 (step S303). Accordingly, the display control unit 66 of the terminal apparatus 60 displays a message indicating an error on the authentication information input screen 360.

When authentication is successful, the identification information registering unit 39 registers the identification information of the terminal apparatus 60 and the user name in the user account information DB 499 (step S304).

In step S304, for example, when each user can only register one piece of identification information of the terminal apparatus 60 in the user account information DB 499, the identification information registering unit 39 determines whether the same reserver account is already registered in the user account information DB 499 (step S305).

When the same reserver account is already registered in the user account information DB 499, the identification information registering unit 39 transmits a message reporting an error to the terminal apparatus 60 (step S307). Accordingly, the display control unit 66 of the terminal apparatus 60 displays a message indicating an error on the authentication information input screen 360 of FIG. 18(c).

When the identification information of the terminal apparatus 60 is registered, the identification information registering unit 39 transmits a message reporting that the registration is completed to the terminal apparatus 60 (step S306). Accordingly, the display control unit 66 of the terminal apparatus 60 displays a message indicating registration completion in the check-in screen 320 of FIG. 18 (a).

As described above, the user can register the identification information of the terminal apparatus 60 at any timing.

### <Main Effects>

As described above, in the resource reservation system 100 according to the present embodiment, check-in is enabled simply by passing the terminal apparatus 60 owned by the user over the conference room terminal 90. Further, the identification information of the terminal apparatus 60 can be registered in the conference management server 30 by passing the terminal apparatus 60 over the conference room terminal 90, and from next time, the check-in can be performed simply by passing the terminal apparatus 60 over the conference room terminal 90.

### <Other Applications>

While the preferred mode for carrying out the present invention has been described with reference to embodiments, the present invention is not limited to the embodiments, and various modifications and substitutions may be made thereto without departing from the spirit and scope of the invention.

For example, there may be a plurality of the conference management servers 30, or the functions of the conference management servers 30 may be distributed among a plurality of servers. The reservation management server 20 and the conference management server 30 may be integrated.

Also, the apparatuses described in the embodiments are merely indicative of one of a plurality of computing environments for carrying out the embodiments disclosed herein. In some embodiments, the conference management server 30 includes a plurality of computing devices, such as a server cluster. The plurality of computing devices are configured to communicate with each other via any type of communication link, including networks, a shared memory, and the like, and perform the processes disclosed herein.

Further, the conference management server 30 may be configured to share the disclosed processing steps, such as those in FIGS. 8 and 12, in various combinations. For example, a process executed by a predetermined unit may be executed by a plurality of information processing apparatuses included in the conference management server 30. The conference management server 30 may be organized into a single server apparatus or may be divided into a plurality of apparatuses.

The resource reservation system 100 according to the present embodiment may also be referred to as a web service. Web services are a variety of services provided by the application of Internet-related technology. Examples include conference room rental services and various rental services. A system that uses web services is referred to as a usage system.

Further, a configuration example such as those illustrated in FIGS. 6 and 7 in the above-described embodiment is divided according to the main functions for easier understanding of the processing of the resource reservation system 100. However, the present invention is not limited by the method of dividing the processing units or the names of the processing units. The resource reservation system 100 may be divided into more processing units depending on the processing contents. Alternatively, one processing unit may be divided to include more processing units.

The functions of the embodiments described above may be implemented by one or more processing circuits. As used herein, a “processing circuit” includes a processor programmed to execute each function by software, such as a processor implemented in electronic circuits, and devices such as an Application Specific Integrated Circuit (ASIC), a digital signal processor (DSP), a field programmable gate array (FPGA), or a conventional circuit module designed to execute each function as described above.

According to one embodiment of the present invention, a resource reservation system with improved convenience when a user starts using a reserved resource, is provided.

The resource reservation system and the resource usage method are not limited to the specific embodiments described in the detailed description, and variations and modifications may be made without departing from the spirit and scope of the present invention.

What is claimed is:

1. A resource reservation system comprising:
an information processing apparatus configured to accept a request to use a resource that is reserved; and
an information processing terminal configured to communicate with a terminal apparatus, wherein
the information processing terminal includes
a communicator configured to transmit, to the information processing apparatus, identification information of the terminal apparatus received from the terminal apparatus, and
the information processing apparatus includes
a resource manager configured to determine whether to allow usage of the resource that is reserved, based on the identification information of the terminal apparatus transmitted from the information processing terminal.

2. The resource reservation system according to claim 1, wherein the information processing terminal displays a message that the resource is being used, upon receiving a report that usage of the resource is allowed.

3. The resource reservation system according to claim 1, wherein the information processing terminal transmits, to the information processing apparatus, the identification information of the terminal apparatus received from the terminal apparatus, without accepting manual input of information from a user.

4. The resource reservation system according to claim 3, wherein
the resource manager is configured to
determine whether to allow usage of the resource based on whether identification information for identifying a reservation of the resource held in advance has been transmitted from the information processing terminal, and
determine whether to allow usage of the resource based on the identification information of the terminal apparatus transmitted from the information processing terminal, without the identification information for identifying the reservation of the resource being transmitted from the information processing terminal.

5. The resource reservation system according to claim 1, wherein
the resource manager is configured to
acquire, from a first storage, identification information of a user of the terminal apparatus that is associated with the identification information of the terminal apparatus transmitted from the information processing terminal, and
determine to allow usage of the resource, upon determining that reservation information of the resource associated with the identification information of the user is registered in a second storage, the reservation information representing a start time of a reservation of the resource that is within a predetermined time period from a current time.

6. The resource reservation system according to claim 5, wherein
upon determining that the identification information of the terminal apparatus transmitted from the information processing terminal is not stored in the first storage,
the information processing apparatus is configured to
request the information processing terminal to provide identification information for identifying the reservation of the resource,
receive the identification information for identifying the reservation of the resource input to the information processing terminal, and
register, in the first storage, the identification information of the user registered as a reserver of the reservation information and the identification information of the terminal apparatus, upon determining that the reservation information, which is identified by the identification information for identifying the reservation of the resource, represents the start time of the reservation that is within the predetermined time period from the current time.

7. The resource reservation system according to claim 6, wherein the resource manager determines to allow usage of the resource, upon determining that the reservation information, which is identified by the identification information for identifying the reservation of the resource, represents the start time of the reservation that is within the predetermined time period from the current time.

8. The resource reservation system according to claim 6, wherein
the information processing terminal, which is requested by the information processing apparatus to provide the identification information for identifying the reservation of the resource, is configured to
display an input screen for inputting the identification information for identifying the reservation of the resource and accept input of the identification information for identifying the reservation of the resource, and
transmit the identification information for identifying the reservation of the resource to the information processing apparatus.

9. A resource usage method performed by a resource reservation system, the resource reservation system including
an information processing apparatus configured to accept a request to use a resource that is reserved; and
an information processing terminal configured to communicate with a terminal apparatus, the resource usage method comprising:
transmitting, by the information processing terminal to the information processing apparatus, identification information of the terminal apparatus received from the terminal apparatus; and
determining, by the information processing apparatus, whether to allow usage of the resource that is reserved, based on the identification information of the terminal apparatus transmitted from the information processing terminal.
